(19) United States
(12) Patent Application Publication
(10) Pub. No.: US 2023/0308956 A1
(43) Pub. Date: Sep. 28, 2023

(54) METHOD AND SYSTEM FOR SETTING UP A CROSS-DOMAIN PRIVATE 5G NETWORK FOR AN ENTERPRISE

(71) Applicant: INFOSYS LIMITED, Bangalore (IN)

(72) Inventors: Kishore BABU THOTA, Chilakaluripet (IN); Amol NILKANTHESHWAR JOSHI, Pune (IN); Gaurav SAXENA, Mount Laurel, NJ (US)

(21) Appl. No.: 17/703,138

(22) Filed: Mar. 24, 2022

(30) Foreign Application Priority Data
Mar. 22, 2022 (IN) 202241015805

(51) Int. Cl. H04W 28/26; H04W 12/02

(52) U.S. Cl. CPC H04W 28/26; H04W 12/02

(57) ABSTRACT

Provided is a method and system for setting up a cross-domain private 5g network for an enterprise. The resources needed for the enterprise locations maybe checked for availability with the network service providers. The resources may include bandwidth, latency, reliability and other related resources as appropriate. Upon checking the resources availability, network slice creation maybe initiated in co-ordination with the service provider. Network slices maybe created in service providers 5G network. The slice resources may also be mapped against the respective service providers. In an embodiment, enterprise user can extend the network slice resource reservation for a specified duration as appropriate.

This application claims the benefit of Indian Patent Application No. 202241015805, filed Mar. 22, 2022, which is incorporated by reference in its entirety.

### FIELD

This technology relates to method and system for setting up a cross-domain private 5G network for an enterprise. More specifically it relates to providing an E2E cross-domain virtual private 5G network solution across various locations of an enterprise.

### BACKGROUND

Mostly enterprises focus on private 5G use cases, having full control on their LAN network. It allows enterprise to define the different network slices to address the LAN private 5G requirements. However, it does not cater across geographies having multiple service providers. Presently all geographies or ends of a communication channel may have separate service providers and hence providing an expected customer service becomes tough.

### SUMMARY

In an embodiment a method for setting up a private 5G network for an enterprise is provided, comprising identifying two or more network service providers catering to the organization, requesting a set of network resources from the identified network service providers for each of two or more locations of the organization, for a predecided time. It further includes creating an end to end network slice for reserving the set of requested network resources for the requested time, and mapping the reserved set of resources.

In an embodiment, a system is provided for setting up a private 5G network for an enterprise, comprising a resource manager (401) for identifying two or more network service providers (411.1, 411.2, 411.n) catering to the organization, a network resource reserver (403.1, 403.2, 403.n) for requesting a set of network resources from the identified network service providers for each of two or more locations of the organization for a predecided time; a network slice life cycle manager (401.2) for creating an end to end network slice for reserving the set of requested network resources, for the requested time, and the network resource reserver (403.1, 403.2, 403.n) mapping the reserved set of resources.

In an embodiment, a computer program product comprising a computer-readable storage media having computer-executable instructions stored thereupon, which when executed by a processor cause the processor to perform a method for setting up a private 5G network for an enterprise, comprising identifying two or more network service providers catering to the organization, requesting a set of network resources from the identified network service providers, for each of two or more locations of the organization for a predecided time; creating an end to end network slice for reserving the set of requested network resources for the requested time; and mapping the reserved set of resources.

### BRIEF DESCRIPTION OF DRAWINGS

FIG. 1 is an embodiment of a network computing environment for implementing the present disclosure;

FIG. 2 is an embodiment of the process for implementing the present disclosure;

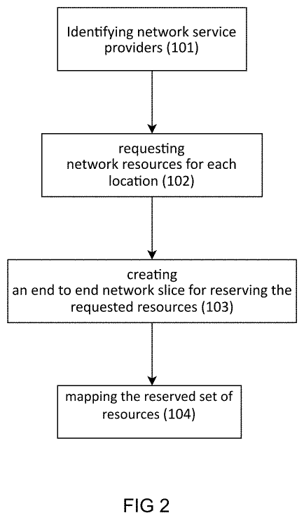

FIG. 3 is an embodiment of the detailed process for implementing the present disclosure; and

FIG. 4 is an embodiment of the system configured to implement the present disclosure.

### DETAILED DESCRIPTION

The present disclosure provides an end-to-end (E2E) private 5G network for large enterprises across different geographic locations delivered via multi service providers' network infrastructure by designing, scheduling, and on-demand dynamic E2E network slice, reserving the resources based on the use case requirement across multiple service providers' network infrastructure. It enables a service provider agnostic platform for enterprises and service providers for seamless enablement of end-to-end private 5G solution.

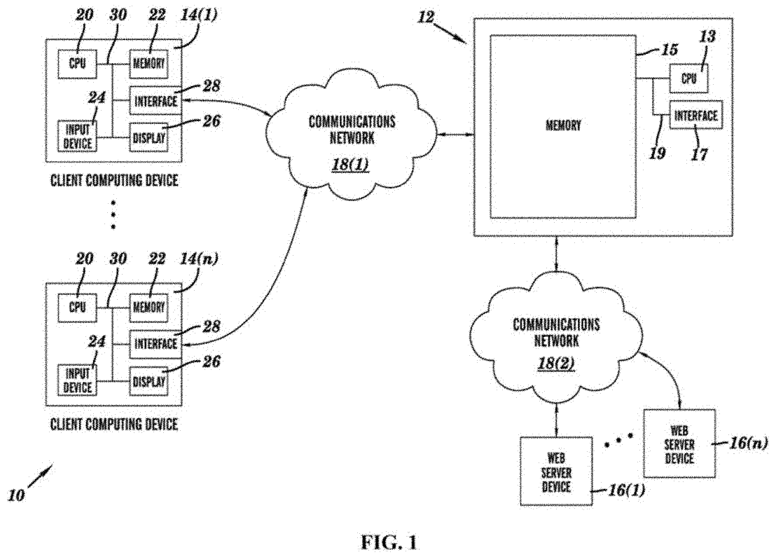

An exemplary environment 10 with a resource managing system 12 configured to provide E2E cross-domain virtual private 5g network is illustrated in FIG. 1. Although this technology can be implemented on other types of devices, such as one of the web server devices 16(1)-16(n), or any other server computing apparatus configured to receive and process hypertext transfer protocol (HTTP) requests, by way of example only. The exemplary environment 10 includes a resource managing system 12, client devices 14(1)-14(n), the web server devices 16(1)-16(n), and communication networks 18(1)-18(2), although other numbers and types of systems, devices, and/or elements in other configurations and environments with other communication network topologies can be used. This technology provides several advantages including providing a method, computer readable medium and an apparatus that can provide access to multiple graph database.

Referring more specifically to FIG. 1, the resource managing system 12 may include a central processing unit (CPU) or processor 13, a memory 15, and an interface system 17 which are coupled together by a bus 19 or other link, although other numbers and types of components, parts, devices, systems, and elements in other configurations and locations can be used. The processor 13 in the resource managing system 12 executes a program of stored instructions for one or more aspects of the present disclosure as described and illustrated by way of the embodiments herein, although the processor could execute other numbers and types of programmed instructions.

The memory 15 in the resource managing system 12 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 13, can be used for the memory 15 in the resource managing system 12.

The interface system 17 in the resource managing system 12 is used to operatively couple and communicate between the resource managing system 12 and the client devices 14(1)-14(n) and the web server devices 16(1)-16(n) via the communication networks 18(1) and 18(2), although other types and numbers of communication networks with other types and numbers of connections and configurations can be used. By way of example only, the communication networks 18(1) and 18(2) can use TCP/IP over Ethernet and industry-standard protocols, including HTTP, HTTPS, WAP, and SOAP, although other types and numbers of communication networks, such as a direct connection, a local area network, a wide area network, modems and phone lines, e-mail, and wireless and hardwire communication technology, each having their own communications protocols, can be used.

Each of the client devices 14(1)-14(n) enables a user to request, receive, and interact with web pages from one or more web sites hosted by the web server devices 16(1)-16(n) through the resource managing system 12 via one or more communication networks 18(1). Although multiple client devices 14(1)-14(n) are shown, other numbers and types of user computing systems could be used. In one example, the client devices 14(1)-14(n) comprise smart phones, personal digital assistants, computers, or mobile devices with Internet access that permit a website form page or other retrieved web content to be displayed on the client devices 14(1)-14(n).

Each of the client devices 14(1)-14(n) in this example is a computing device that includes a central processing unit (CPU) or processor 20, a memory 22, user input device 24, a display 26, and an interface system 28, which are coupled together by a bus 30 or other link, although one or more of the client devices 14(1)-14(n) can include other numbers and types of components, parts, devices, systems, and elements in other configurations. The processor 20 in each of the client devices 14(1)-14(n) executes a program of stored instructions for one or more aspects of the present invention as described and illustrated herein, although the processor could execute other numbers and types of programmed instructions.

The memory 22 in each of the client devices 14(1)-14(n) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to processor 20 can be used for the memory 22 in each of the client devices 14(1)-14(n).

The user input device 24 in each of the client devices 14(1)-14(n) is used to input selections, such as requests for a particular website form page or to enter data in fields of a form page, although the user input device could be used to input other types of data and interact with other elements. The user input device can include keypads, touch screens, and/or vocal input processing systems, although other types and numbers of user input devices can be used.

The display 26 in each of the client devices 14(1)-14(n) is used to show data and information to the user, such as website or application page by way of example only. The display in each of the client devices 14(1)-14(n) can be a mobile phone screen display, although other types and numbers of displays could be used depending on the particular type of client device 14(1)-14(n).

The interface system 28 in each of the client devices 14(1)-14(n) is used to operatively couple and communicate between the client devices 14(1)-14(n), the resource managing system 12, and the web server devices 16(1)-16(n) over the communication networks 18(1) and 18(2), although other types and numbers of communication networks with other types and numbers of connections and configurations can be used.

The web server devices 16(1)-16(n) provide web content such as one or more pages from one or more web sites for use by one or more of the client devices 14(1)-14(n) via the resource managing system 12, although the web server devices 16(1)-16(n) can provide other numbers and types of applications and/or content and can provide other numbers and types of functions. Although the web server devices 16(1)-16(n) are shown for ease of illustration and discussion, other numbers and types of web server systems and devices can be used.

Each of the web server devices 16(1)-16(n) include a central processing unit (CPU) or processor, a memory, and an interface system which are coupled together by a bus or other link, although each of the web server devices 16(1)-16(n) could have other numbers and types of components, parts, devices, systems, and elements in other configurations and locations. The processor in each of the web server devices 16(1)-16(n) executes a program of stored instructions one or more aspects of the present invention as described and illustrated by way of the embodiments herein, although the processor could execute other numbers and types of programmed instructions.

The memory in each of the web server devices 16(1)-16(n) stores these programmed instructions for one or more aspects of the present invention as described and illustrated by way of the embodiments described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory in each of the web server devices 16(1)-16(n).

The interface system in each of the web server devices 16(1)-16(n) is used to operatively couple and communicate between the web server devices 16(1)-16(n), the database accessing system 12, and the client devices 14(1)-14(n) via the communication networks 18(1) and 18(2), although other types and numbers of communication networks with other types and numbers of connections and configurations can be used.

Although embodiments of the resource managing system 12, the client devices 14(1)-14(n), and the web server devices 16(1)-16(n), are described and illustrated herein, each of the client devices 14(1)-14(n), the resource managing system 12, and the web server devices 16(1)-16(n), can be implemented on any suitable computer system or computing device. It is to be understood that the devices and systems of the embodiments described herein are for exemplary purposes, as many variations of the specific hardware and software used to implement the embodiments are possible, as will be appreciated by those skilled in the relevant art(s).

Furthermore, each of the systems of the embodiments may be conveniently implemented using one or more general purpose computer systems, microprocessors, digital signal processors, and micro-controllers, programmed according to the teachings of the embodiments, as described and illustrated herein, and as will be appreciated by those ordinary skill in the art.

In addition, two or more computing systems or devices can be substituted for any one of the systems in any of the embodiments. Accordingly, principles and advantages of distributed processing, such as redundancy and replication also can be implemented, as desired, to increase the robustness and performance of the devices and systems of the embodiments. The embodiments may also be implemented on computer system or systems that extend across any suitable network using any suitable interface mechanisms and communications technologies, including by way of example only telecommunications in any suitable form (e.g., voice and modem), wireless communications media, wireless communications networks, cellular communications networks, G3 communications networks, Public Switched Telephone Network (PSTNs), Packet Data Networks (PDNs), the Internet, intranets, and combinations thereof.

The embodiments may also be embodied as a non-transitory computer readable medium having instructions stored thereon for one or more aspects of the present invention as described and illustrated by way of the embodiments herein, as described herein, which when executed by a processor, cause the processor to carry out the steps necessary to implement the methods of the embodiments, as described and illustrated herein.

An embodiment of the major steps of the process will now be explained along with FIG. 1. In an embodiment, once an enterprise or an organization creates a request for an e2e 5g network, the resource managing system may identify the multiple network service providers catering to the enterprise in various locations (101). The enterprise may have a separate network service provider for each of its geography or location. There may be multiple requests received from more than one user.

In one embodiment, the resources needed for the locations maybe checked for availability with the network service providers (102). The resources may include bandwidth, latency, reliability and other related resources as appropriate. Upon checking the resources availability, network slice creation maybe initiated (103) in co-ordination with the service provider. Network slices maybe created in service providers 5G network. The slice resources may also be mapped against the respective service providers. In an embodiment, enterprise user can extend the network slice resource reservation for a specified duration as appropriate.

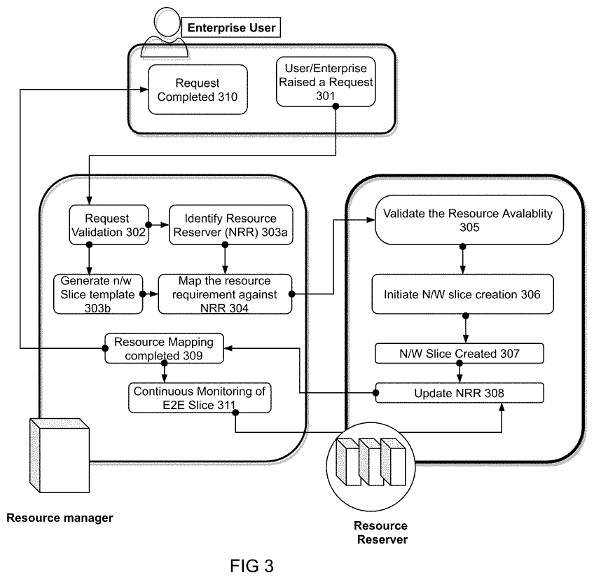

A detailed explanation of an embodiment of the process to implement the present disclosure will now be explained along with FIG. 3. In an embodiment, an enterprise user may initiate an e2e network slice creation request. The enterprise user may be looking for a solution which connect their resources across various remote along with mobile locations securely over one single uniform network. There may be various use cases when an enterprise user may need a 5g network across locations. In one embodiment, a resource manager may receive a request from an enterprise user, or more than one enterprise user. The resource manager may try to analyze and accordingly understand the requirements of the enterprise user. Analyzing may include understanding the network service requirement. In an embodiment the analysis may be based on the use case across different part of network infrastructure, span across multiple service provider domain.

A network slice Life Cycle Manager (LCM) configured by the resource manager processes the request. An LCM may be responsible for life cycle management of the network slices among 5g service provider networks and a network slice exchange (NWSE). An NWSE may provide an end-to-end network slice bridge between two different service provider's networks infrastructure.

In one embodiment, network slice LCM may validate the requested initiated by the enterprise user (302). The validation may be done based on what are the requirements of the enterprise user, and what are the resources that may be needed. The LCM may also validate the service providers catering at the various locations of the enterprise. The validations may also include different or further appropriate factors.

In an embodiment, once the request is validated, network slice LCM may identify the service providers' Network Resource Reserver (NRR) (303a). In an embodiment, NRR maybe a dedicated entity or a component in the service provider network to manage network slices. NRR may be identified based on the location of the 5G network and the service provider. It may generate the network slice templates (303b) which will be used to create the network slices. NRR may reserve or release resources at the service provider level by integrating with its control plane components based on the requirement received from enterprise user.

In an embodiment, the network slice template may include information about the required resources, for instance the list of network functions (NF) that may be required at the core network level of the specific service provider. The template may also include the required configurations and policies for RAN, xhaul (Front/Middle/Back) and transport network as well, at the network slice exchange. Once the slice template is generated, it may map the reserved resources to the identified NRR for the service providers. This may provide the NRR with the information of the resources it should reserve for the enterprise.

In an embodiment the NRR then checks the availability of the mapped resources (305). It may check the availability of the mapped bandwidth, mapped latency and other such mapped resources. Each of the NRR may check the resource availability at the level of the service provider. The resource availability may also be checked at the Network Slice Exchange (NSE) to verify if whether if the required resources are available to create the slice at the NSE, specific to the enterprise activity as per the related policies and configurations.

In one embodiment, an NSE may provide secure data plane communication over the created network slice among multiple service provider 5g networks. In an embodiment, the NSE may also set up an end-to-end network slice bridge between two different service provider's 5G networks infrastructure. This may be done by extending the user plane function (UPF) from one service provider domain to other ensuring dedicated secure channel of communication. It may maintain same characteristic of deployed network slice end-to-end, to provide exact same end user experience across multiple service provider domain.

In an embodiment, after checking the availability of resources and performing all validations, the network slice may then be created from the network slice template, at service provider domain, and at NSE as well (306, 307). Network slices may get created in service providers 5G network and extended towards the NSE. The network slices created at the NSE may enable mapping of the global UPF and the communication channel between the service providers. Once the network slices are created, the enterprise can access the 5g network across various locations providing same user experience across multiservice provider domain.

In an embodiment, each slice may have a start time and an end time. The NRR may be updated with these details so that resources can be reserved accordingly. In an embodiment slice duration may need to be extended. An update request may be sent to the NRRs to extend the slice duration across service provider domains otherwise it will be decommissioned as per the end time (308).

In an embodiment, the resource mapping maybe completed as soon as network slice is completed. The enterprise may be able to access resources seamlessly across the geographies (309). The enterprise may be informed that the request is completed (310).

In one embodiment, the LCM may initiate the network slice monitoring. LCM may be configured to monitor the life cycle management of the network slices among service provider networks and network slice exchange. In an embodiment LCM may collect the notifications, performance metrics and other related data from the network slices. It may be configured to analyze the data for root cause analysis in case of errors. LCM may also be configured for report generation of the network slice performance and usage (311).

In an embodiment, a network slice creation may be created for a scheduled or a predecided time duration. The enterprise user may also request extension for this time. The enterprise user may need to inform the time extension it needs. The NRR may then check the resource availability and mapping, and accordingly decide if the network slice may be extended or not.

In one embodiment, the enterprise user may request closing the private 5g network. On receiving the request to close the 5g network, the network slice is decommissioned or deleted, and it may be removed across service provider domains as well as neutral network slice exchange.

In one embodiment, the network slice creation may also be scheduled for creation at a later time. When a request is received from an enterprise, the creation of the network may be scheduled for a different time.

In an embodiment, for the implementation of the above process along with all embodiments APIs may be exposed which can be used by the north bound operations support systems or orchestrator systems to initiate the network slice creation.

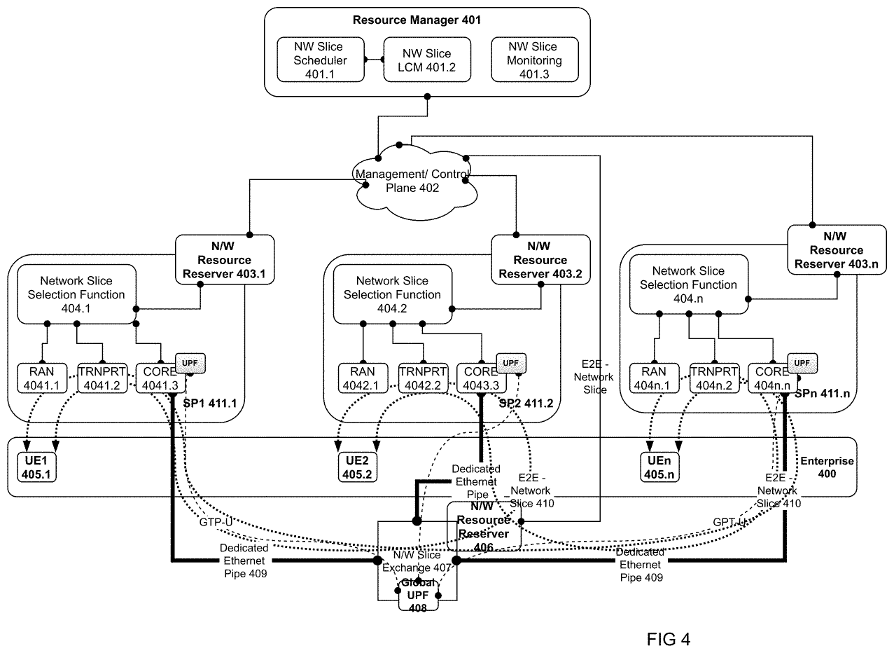

An embodiment of the system configured to enable the present disclosure will now be explained along with FIG. 4.

In an embodiment, an enterprise (400) may need a private 5g network across its multiple locations. For the purpose of this document, each of the locations may be represented as a user equipment (UE1 . . . UEn) (405.1 . . . 405.n). Each of the user equipment may be catered by a separate service provider (SP1 . . . SPn) (411.1 . . . 411.n). In one embodiment it may be common service provider for some of the user equipment.

In one embodiment when an enterprise requests a 5g network, a resource manager 401 is configured to initiate the process. The resource manager 401 may house a network slice scheduler (401.1), a network slice life cycle manager (LCM) 401.2, and a network slice monitoring (401.3).

In an embodiment, the network slice scheduler (401.1) may be configured for scheduling the end-to-end network slice creation. It may also schedule configuration, activation and decommission of the network slices among service provider 5G networks, as maybe required by the enterprise user. Network slice scheduler (401.1) may be functional when the enterprise user may need to schedule the creation or other processing of network slice. In an embodiment the network slice scheduler (401.1) may be integrated with the network LCM (401.2) using the north bound APIs. The required functions may be scheduled for a later time or day. Network slicing may also be scheduled for a customized date & time interval. It may also reschedule or cancel the scheduled network slices. In an embodiment, this may be implemented using an operation support system in a Network Functions Virtualization orchestrator via the APIs.

In one embodiment the network slice life cycle manager (NW LCM) (401.2) may be configured for life cycle management of the network slices among service provider networks and a network slice exchange. Life cycle management may include creation, configuration, activation, upgradation, and deletion of a network slice. This may also be as per the schedule set by the network slice scheduler (401.1). The NW LCM (401.2) may have data related to the life cycle of multiple network slices scheduled at various time intervals, and the network slices requested and completed or deleted earlier.

In an embodiment, network slice managing as mentioned above may be implemented by invoking the north bound APIs exposed by the respective 5G service provider via Network Resource Reserver (NRR) deployed at each service provider network. This may include the network slices management across its:
Radio Access Network (RAN);
Transport Network;
Core Network

In one embodiment, the network slice monitor (401.3) may be configured to monitor the performance and issue resolution for the network slices. It may be configured for the analysis of the failures or errors faced by the network slices. The network slice monitor may also be configured to store the data relating to the various performance parameters of the network slices. In one embodiment, the network slice monitor (401.3) may be configured to provide a report for the errors and the performance analysis over a required time period for the various network slices.

In an embodiment the control and management plane (402) may be configured to keep a track of the health and performance of network resource. It may also be configured, along with a network resource reserver (NRR) (403.2) to reserve resources with the service provider and NSE. The control and management plane may be configured to keep a track of the health and performance of network resource. It may receive the monitoring request from the NW Slice Monitoring 401.3 and transmit the same to the NRR. In one embodiment, the NRR (403.1 . . . 403.n) may be a part of each of the service provider. It may be configured to integrate with the management and control plane to enable the monitoring and resource handling.

In an embodiment, network slice selection function (404) may be configured to select appropriate network slice based on the user requirements. There may be multiple requirements from multiple users and the network slice selection function (404) may enable selecting the network slice for the users. It may check the user access control using the core network functions, and accordingly enable the network slices for the user.

In an embodiment, RAN (4041.1 . . . 404n.1), Trnprt (4041.2 . . . 404n.2), CORB (4041.3 . . . 404n.3) maybe few of the resources available with each service provider (411.1 . . . 411.n). These may be any number of resources as available with a service provider.

In one embodiment, the resource manager (401) further has a network slice exchange (407). The network slice exchange (407) may be configured to setting up end to end n/w slice bridge between two different service provider's network infrastructure. The network slice exchange (407) may extend the UPF from one service provider domain to other, ensuring dedicated channel of communication, enabling an exact same end user experience across multiple service provider domain. In an embodiment, the network slice exchange (407) may use Ethernet pipe (409) between the service providers, to set up network slice bridge between service providers. These may be dedicated Ethernet pipes.

In an embodiment the resource manager may provide a GUI based on RBAC for various types of users by integrating with the enterprise system. It may provide an access control based on the roles like admin or operator, and this will be integrated with the enterprise authentication authorization systems to control the access as per the roles and responsibilities in the enterprise.

In one embodiment global UPF (408) maybe a neutral User Plane function (UPF) as part of the Network Slice Exchange (407) for routing the data between the service provider 5G networks through Ethernet pipes (409). In one embodiment, Ethernet pipers maybe dedicated connectivity circuits.

Accordingly, the present disclosure provides end-to-end private 5g network across different locations, by designing, scheduling, and on-demand dynamic network slice, reserving the resources based on the use case requirement across multiple service providers' network infrastructure, commissioning and/or decommissioning of network slices to support various use cases of enterprise.

An embodiment of the implementation of the present disclosure will now be explained through an example. Let us consider that a chain of hospital across the globe is looking for a solution which connect their resources viz. Dispensaries deployed in rural areas, hospitals deployed in Metros in India, USA, Australia, Doctors, Nursing Staff, Medical suppliers, Operation Theaters, medical equipment(s), Ambulance, etc. securely over one single uniform network. Single Service provider could not cater all location as some sites are at remote places in rural areas where it may not have its presence. Ambulances are mobile in nature and cannot be covered with fixed wireline network, not all locations are having all specialized doctors. The use case requires to have a reliable secure communication channel for doctors to communicate remotely with the remote patients.

The resource manager discussed earlier will enable maintaining the same user experience irrespective of location of hospital site serviced by different service provider. It will be act as Single point of Contact for the hospital, to set-up any kind of communication between its resources. According to the nature of communication, this resource manager will initiate resource reservation across multiple domains. Other components of this framework viz. Network Resource Reserver [NRR] will ensure this reservation and its health check locally at each Service Provider [SP] level, and Network Slice Exchange [NWSE] will build the secured communication channel among these service providers.

Let us consider the example that the hospital has scheduled a network slice request for remote critical operation (Heart Transplant) at Hospital A and Hospital B. Due to time constraint couple of doctors will be joining this operation remotely as they might not be able to travel.

In this example, let us consider a heart needs to be carry from Hospital A where the donor is hospitalized to the Hospital B where the recipient is admitted. The corresponding network slice needs to be extended to the ambulance as well to continuously monitor the health of heart during transit. It is also required that the network slice should support this IOT communication and frequently send out the health report of all equipment to the hospital's staff.

The resource manager will analyze each communication flow. Then it will identify all stake holder service provider domains and will initiate the resource reservation request. Upon receiving request at each SP level, NRR will initiate the network slicing creation under respective SP domain in coordination with SP's control plane components. Once the slice is created successfully at each SP level NRR will send feedback to the resource manager. Network Slice Exchange will also reserve the resources and extend the UPF among different SPs. Upon receiving feedback from all NRRs, the resource manager will inform the hospital about the request completion. Also, on periodic interval NRR will provide the health check report for the network slice deployed in each SP domain.

Upon reaching to threshold of scheduled duration for given network slice request, the resource manager will inform user to ask for any extension. Based on the customer feedback the decommissioning of the network slice will be triggered automatically. Alternatively, upon completion of the operation the hospital needs to trigger another request for decommission separately.

In an embodiment, an enterprise user may request a prolong 5g network for its locations. This may be requested for monthly requirements or more as needed.

In one embodiment, different type of network slices can be created, depending on the enterprise use case for instance eMBB, mMTC, URLLC or other such network slice types. Accordingly, there may be multiple network slice templates also created.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

We claim:

1. A method for setting up a private 5G network for an enterprise, comprising
identifying two or more network service providers catering to the organization;
requesting a set of network resources from the identified network service providers, for each of two or more locations of the organization, for a predecided time;
creating an end to end network slice for reserving the set of requested network resources, for the requested time; and
mapping the reserved set of resources.

2. The method as claimed in claim 1, comprising
receiving a request for the private 5G network; and
validating the received request for the requested resources.

3. The method as claimed in claim 1, wherein creating the network slice comprises
generating a network slice template;
mapping the requested set of resources with a resource reserver; and
validating availability of the mapped resources.

4. The method as claimed in claim 1, comprising extending a user plane between the identified network service providers using a communication channel.

5. The method as claimed in claim 1, comprising monitoring the created network slices.

6. The method as claimed in claim 1, comprising decommissioning the created network slices.

7. A system for setting up a private 5G network for an enterprise, comprising
a resource manager for identifying two or more network service providers catering to the organization;
a network resource reserver for requesting a set of network resources from the identified network service providers, for each of two or more locations of the organization, for a predecided time;
a network slice life cycle manager for creating an end to end network slice for reserving the set of requested network resources, for the requested time; and
the network resource reserver mapping the reserved set of resources.

8. The system as claimed in claim 7, wherein the system is configured for
receiving a request for the private 5G network; and
validating the received request for the requested resources.

9. The system as claimed in claim 7, wherein creating the network slice comprises
generating a network slice template;
mapping the requested set of resources with a resource reserver; and
validating availability of the mapped resources.

10. The system as claimed in claim 7, comprising extending a user plane between the identified network service providers using a communication channel.

11. The system as claimed in claim 7, configured for comprising monitoring the created network slices.

12. The system as claimed in claim 7, configured for comprising decommissioning the created network slices.

13. A computer program product comprising a computer-readable storage media having computer-executable instructions stored thereupon, which when executed by a processor cause the processor to perform a method for setting up a private 5G network for an enterprise, comprising
identifying two or more network service providers catering to the organization;
requesting a set of network resources from the identified network service providers, for each of two or more locations of the organization, for a predecided time;
creating an end to end network slice for reserving the set of requested network resources, for the requested time; and
mapping the reserved set of resources.

14. The computer program product as claimed in claim 13, comprising
receiving a request for the private 5G network; and
validating the received request for the requested resources.

15. The computer program product as claimed in claim 13, wherein creating the network slice comprises
generating a network slice template;
mapping the requested set of resources with a resource reserver; and
validating availability of the mapped resources.

16. The computer program product as claimed in claim 13, comprising extending a user plane between the identified network service providers using a communication channel.

17. The computer program product as claimed in claim 13, comprising monitoring the created network slices.

18. The computer program product as claimed in claim 13, comprising decommissioning the created network slices.
